(19) United States
(12) Patent Application Publication
(10) Pub. No.: US 2010/0162974 A1
(43) Pub. Date: Jul. 1, 2010

(54) WATER PUMP ATTACHMENT STRUCTURE OF WATER-COOLED INTERNAL COMBUSTION ENGINE

(76) Inventors: Teruhide YAMANISHI, Saitama (JP); Ryuji Tsuchiya, Saitama (JP); Kenji Oki, Saitama (JP); Yutaka Miyake, Saitama (JP)

Correspondence Address: BIRCH STEWART KOLASCH & BIRCH, PO BOX 747, FALLS CHURCH, VA, 22040-0747, US

(21) Appl. No.: 12/635,398

(22) Filed: Dec. 10, 2009

(30) Foreign Application Priority Data
Dec. 26, 2008 (JP) 2008-333801

(51) Int. Cl. F01P 5/10; F02B 77/00

(52) U.S. Cl. 123/41.47; 123/195 C

(57) ABSTRACT

A water pump attachment structure of a water-cooled internal combustion engine is provided to facilitate the maintenance of a valve train. A water pump attachment structure of a water-cooled internal combustion engine includes a semicircular cut-away surface of a water pump holder opposed to a semicircular surface of a cylinder head to form a water pump support circular hole. Screw members are passed through respective screw through-holes of the cylinder head and threadedly engaged with internal thread holes of the water pump holder. Thus, the water pump holder is fastened to the cylinder head. A water pump is fitted into and secured to the water pump support circular hole. A cylinder head cover is attached to the cylinder head by allowing their mating surfaces to conform with each other with the water pump holder liquid-tightly sandwiched therebetween.

### CROSS-REFERENCE TO RELATED APPLICATIONS

The present application claims priority under 35 USC 119 to Japanese Patent Application No. 2008-333801 filed on Dec. 26, 2008 the entire contents of which are hereby incorporated by reference.

### BACKGROUND OF THE INVENTION

1. Field of the Invention

The present invention relates to a water pump attachment structure of a water-cooled internal combustion engine.

2. Description of Background Art

A water-cooled internal combustion engine is known wherein a valve train having a camshaft disposed on a cylinder head is provided so as to be covered by a cylinder head cover. This internal combustion engine is configured as described below. A water pump housing for a water pump is provided across the cylinder head and cylinder head cover. In addition, a pump drive shaft rotatably supported in the water pump housing is disposed coaxially with a camshaft and rotated in conjunction with the rotation of the camshaft. See, for example, Japanese Patent No. 3,963,532.

Japanese Patent No. 3,963,532 discloses a water pump housing that is provided across the cylinder head and the cylinder head cover is attached to and supported by both the cylinder head and the cylinder head cover by means of bolts.

When the maintenance of the valve train such as adjustment of a tappet clearance is carried out, to remove the cylinder head cover, the water pump housing for the water pump has to be first removed from the cylinder head and the cylinder head cover. More specifically, work has to be done from a plurality of lateral sides of the engine, which makes the maintenance work cumbersome.

### SUMMARY AND OBJECTS OF THE INVENTION

It is an object of an embodiment of the present invention to provide a water pump attachment structure for a water-cooled internal combustion engine that can facilitate the maintenance of a valve train.

According to an embodiment of the present invention, a water pump attachment structure of a water-cooled internal combustion engine is provided wherein a valve train having a camshaft disposed on a cylinder head is provided so as to be covered by a cylinder head cover. A water pump having a pump drive shaft directly driven by the camshaft is disposed across a mating surface of the cylinder head. A mating surface of the cylinder head cover is provided wherein the cylinder head has a sidewall formed with a semicircular cut-away surface resulting from cutting away the mating surface with the cylinder head cover in a semicircle with screw boss portions having screw through-holes passing through the mating surface. The screw boss portions are formed on both sides of the semicircular cut-away surface. A water pump holder is formed with a semicircular cut-away surface symmetrically opposed to the semicircular cut-away surface of the cylinder head, and with internal thread holes in the mating surface with the cylinder head so as to correspond to the respective screw through-holes to form a water pump support circular hole by allowing a semicircular cut-away surface thereof to face the semicircular cut-away surface of the cylinder head. Screw members are passed through the respective screw through-holes of the cylinder head and are threadedly engaged with the respective internal thread holes of the water pump holder so that the water pump holder is fastened to the cylinder head. A water pump is fitted into and secured to the water pump support circular hole. The cylinder head cover includes a mating surface allowed to conform to the mating surface of the cylinder head and is attached to the cylinder head with the water pump holder liquid-tightly sandwiched therebetween.

According to an embodiment of the present invention, the water pump holder is positioned with respect to and fastened to the cylinder head by a knock pin engaged with an engaging hole formed at a given position on the mating surface of the cylinder head and of the water pump holder.

According to an embodiment of the present invention, the screw through-holes of the cylinder head are formed adjacently to both respective sides of the semicircular cut-away surface, and the semicircular cut-away surface of the cylinder head has an axial width greater than an internal diameter of the screw through-hole.

According to an embodiment of the present invention, the corresponding semicircular cut-away surfaces of the water pump support circular hole formed by fastening the water pump holder to the cylinder head are subjected to planarization by a co-process, and a cylindrical portion of a water pump housing rotatably supporting the pump drive shaft of the water pump is liquid-tightly fitted into the water pump support circular hole via an O-ring to support the water pump.

According to an embodiment of the present invention, a cylindrical portion of a water pump housing rotatably supporting the pump drive shaft of the water pump is formed with a flange portion, and the cylindrical portion of the water pump housing is fitted into the water pump support circular hole so that the flange portion is liquid-tightly abutted against an external opening end face of the water pump support circular hole via an O-ring to support the water pump.

According to an embodiment of the present invention, an external sidewall defining a cam chain chamber of the cylinder head is formed with a water pump attachment bolt boss portion adapted to secure the water pump and with a cylinder head fastening bolt boss portion adapted to fasten the cylinder head to a cylinder block.

According to an embodiment of the present invention, the water pump holder, formed with a semicircular cut-away surface symmetrically opposed to the semicircular cut-away surface of the cylinder head, and with internal thread holes in the mating surface with the cylinder head so as to correspond to the respective screw through-holes, forms a water pump support circular hole by allowing a semicircular cut-away surface thereof to face the semicircular cut-away surface of the cylinder head. Screw members are passed through the respective screw through-holes of the cylinder head and threadedly engaged with the respective internal thread holes of the water pump holder so that the water pump holder is fastened to the cylinder head. The water pump is fitted into and secured to the water pump support circular hole. The cylinder head cover has the mating surface allowed to conform to the mating surface of the cylinder head and is attached to the cylinder head with the water pump holder liquid-tightly sandwiched therebetween. Thus, while maintaining the state where the water pump is fitted into the water pump support circular hole and secured to the cylinder head, the cylinder head cover is removed and maintenance work for the valve train 10 such as the adjustment of a tappet clearance can be done with ease.

In addition, in the state where the cylinder head cover is put on and fastened to the cylinder head, also the water pump can be removed. Therefore, maintenance work for the water pump can be done with ease.

In addition, the water pump having the pump drive shaft directly driven by the camshaft is disposed across the mating surface of the cylinder head and of the cylinder head cover. Therefore, the mating surfaces are made flush with the camshaft to lower the lateral wall of the cylinder head, thereby reducing the weight of the cylinder head.

According to the water pump attachment structure of the water-cooled internal combustion engine, the water pump holder is positioned with respect to and fastened to the cylinder head by a knock pin engaged with an engaging hole formed at a given position on the mating surface of the cylinder head and of the water pump holder. Thus, the accuracy of the attachment position of the water pump holder to the cylinder head can be highly maintained.

According to the water pump attachment structure of the water-cooled internal combustion engine, the screw through-holes of the cylinder head are formed adjacent to both respective sides of the semicircular cut-away surface, and the semicircular cut-away surface of the cylinder head has an axial width greater than an internal diameter of the screw through-hole. Therefore, while the axial width of the semicircular cut-away surface is increased to make the support of the water pump satisfactory, the broad semicircular cut-away surface is used to enlarge the screw boss portion of the screw through-hole, thereby achieving an increase in boss strength.

According to the water pump attachment structure of the water-cooled internal combustion engine, the corresponding semicircular cut-away surfaces of the water pump support circular hole formed by fastening the water pump holder to the cylinder head are subjected to planarization by a co-process. Therefore, the water pump support circular hole can be formed as a perfect-circular hole surface with a high degree of accuracy. In addition, the cylindrical portion of a water pump housing rotatably supporting the pump drive shaft of the water pump is liquid-tightly fitted into the water pump support circular hole via an O-ring. With such a simple structure, a high sealing-performance can be ensured.

According to the water pump attachment structure of the water-cooled internal combustion engine, the cylindrical portion of a water pump housing rotatably supporting the pump drive shaft of the water pump is formed with the flange portion, and the cylindrical portion of the water pump housing is fitted into the water pump support circular hole so that the flange portion is liquid-tightly abutted against the external opening end face of the water pump support circular hole via the O-ring to support the water pump. With such a simple structure, the sealing performance can be highly maintained without a co-process.

According to the water pump attachment structure of the water-cooled internal combustion engine, the external sidewall defining the cam chain chamber of the cylinder head is formed with the water pump attachment bolt boss portion adapted to secure the water pump and with the cylinder head fastening bolt boss portion adapted to fasten the cylinder head to a cylinder block. Therefore, the external sidewall of the cam chain chamber is formed with the bulging water pump attachment bolt boss portion and with the bulging cylinder head fastening bolt boss portion to increase the rigidity of the cylinder head in the vicinity of the cam chain chamber. Thus, the strength of the cylinder head fastening portion can be increased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross-sectional view illustrating the vicinity of a cylinder head of an internal combustion engine according to an embodiment of the present invention;

FIG. 2 is an exploded cross-sectional view illustrating the vicinity of the cylinder head of the internal combustion engine with a water pump removed;

FIG. 3 is an exploded lateral view of FIG. 2;

FIG. 4 is a plan view of the cylinder head;

FIG. 5 is a back view of a water pump holder;

FIG. 6 is a back view of a cylinder head cover;

FIG. 7 is an exploded cross-sectional view of the internal combustion engine with the cylinder head cover and a water pump removed;

FIG. 8 is a lateral view of an essential portion of the internal combustion engine; and

FIG. 9 is a cross-sectional view illustrating the vicinity of a cylinder head of an internal combustion engine according to another embodiment.

### DETAILED DESCRIPTION OF THE PREFERRED EMBODIMENTS

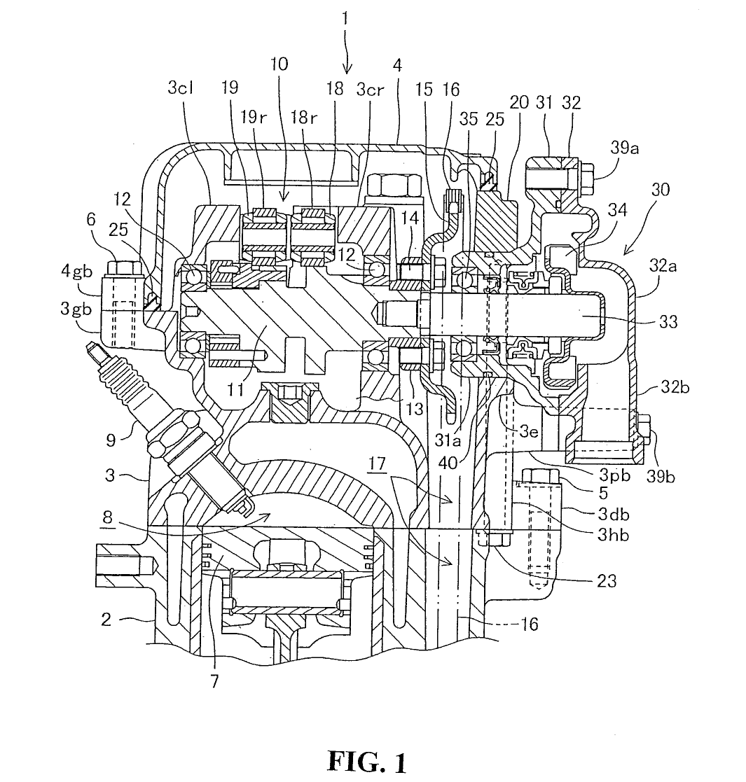

An embodiment according to the present invention will hereinafter be described with reference to FIGS. 1 to 8.

A water-cooled internal combustion engine 1 of the present embodiment is an internal combustion engine that adopts a single-cylinder 4-stroke SOHC valve system and is mounted on small-sized vehicles.

FIG. 1 is a cross-sectional view illustrating the vicinity of a cylinder head 3 of the internal combustion engine 1.

The internal combustion engine 1 is mounted on a vehicle body so that a crankshaft is oriented in a width direction of the vehicle body and a cylinder is forwardly inclined. In the present embodiment, the vehicle body width direction is a left-right direction and the projecting direction of the cylinder is upside.

The cross-sectional view of FIG. 1 is such that left, right, up and down are indicated without modification.

The cylinder head 3 is put on a cylinder block 2 and both are fastened to each other by means of fastening bolts 5.

A valve train 10 provided on the upper portion of the cylinder head 3 is covered from above by a cylinder head cover 4, which is fastened to the cylinder head 3 by means of fastening bolts 6.

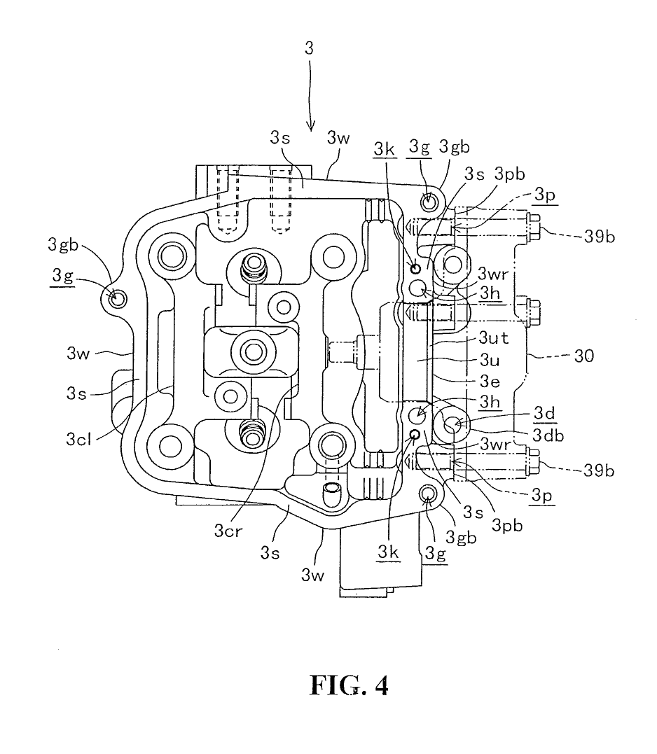

Referring to FIG. 4, the cylinder head 3 is such that an end face of a rectangular outer lateral wall 3w is formed as a mating surface 3s with the cylinder head cover 4. In addition, a pair of left and right cam shaft-receiving walls 3cl, 3cr are formed on the inside surrounded by the outer lateral wall to project further upward from the mating surface 3s.

A camshaft 11 is rotatably mounted to the left and right camshaft-receiving walls 3cl, 3cr via respective bearings 12, 12 so as to extend in a left-right horizontal direction.

The central axis of the camshaft 11 lies on the same plane as the mating surface 3s of the cylinder head 3 with the cylinder head cover 4.

An annular attachment base 13 is fitted to a right end projecting from the right bearing 12 of the camshaft 11. A cam chain driven sprocket 15 is secured to the attachment base 13 by means of bolts 14 (see FIG. 1).

A cam chain 16 adapted to transmit power to the valve train 10 is spanned between the cam chain driven sprocket 15 fitted to the right end of the camshaft 11 and a cam chain drive sprocket (not illustrated) fitted to a crankshaft (not illustrated). Cam chain chambers 17 for such a cam chain and sprockets are provided in the cylinder block 2 and the cylinder head 3 to communicate with each other (see FIG. 1).

An intake cam surface and an exhaust cam surface of the cam shaft 11 are in contact with a roller 18r at an end of the intake rocker arm 18 and with a roller 19r at an end of the exhaust rocker arm 19, respectively.

In addition, in the cylinder head 3, an ignition plug 9 is obliquely inserted from the side (the left side) opposite the cam chain chamber 17 toward a combustion chamber 8 the top of a piston 7 faces (see FIG. 1).

In the internal combustion engine 1, a water pump 30 is attached between the respective mating surfaces 3s, 4s of the right sidewalls 3wr, 4wr in the respective external lateral walls 3w, 4w included in the cylinder head 3 and the cylinder head cover 4.

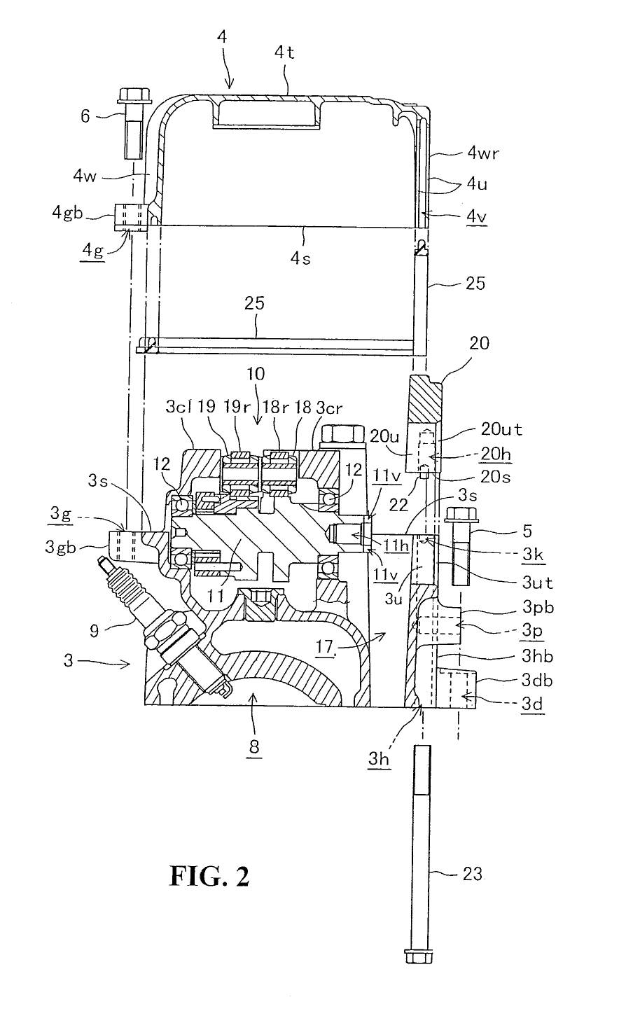

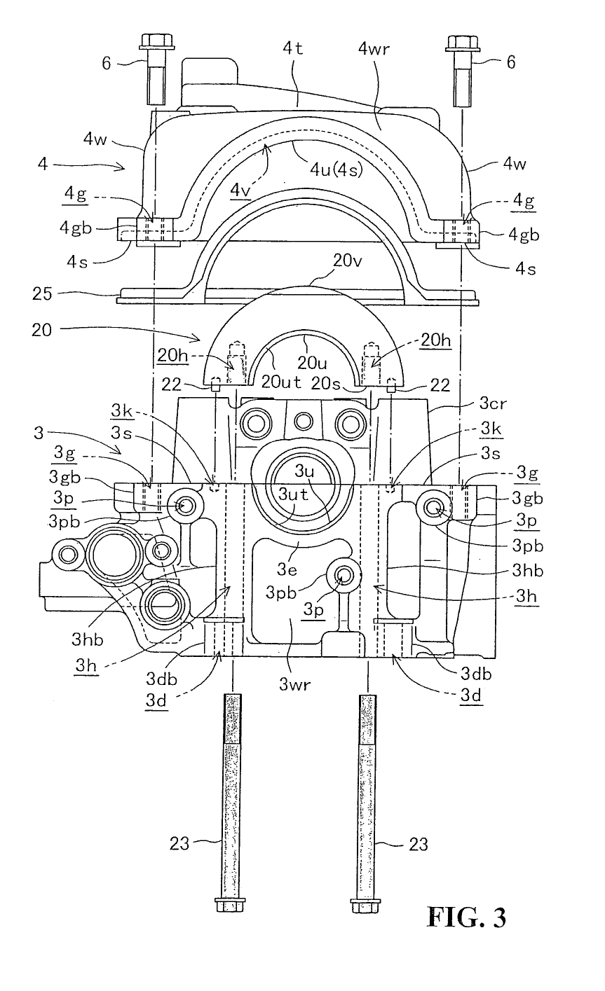

With reference to FIGS. 2 and 3, the respective mating surfaces 3s, 4s of the right sidewalls 3wr, 4wr of the cylinder head 3 and the cylinder head cover 4 are partially formed with respective semicircular notch surfaces 3u, 4u each cut away in a semicircle to face each other. The semicircular cut-away surface 4u of the cylinder head cover 4 has an inner diameter greater than that of the semicircular cut-away surface 3u of the cylinder head 3.

A water pump holder 20 is sandwiched and interposed between the semicircular cut-away surface 4u of the cylinder head cover 4 and the mating surface of the right sidewall 3wr of the cylinder head 3. This water pump holder 20 is formed in a hollow semicircular plate obtained by halving a hollow circular plate by a diameter, the hollow circular plate having an inner diameter equal to that of the semicircular cut-away surface 3u of the cylinder head 3 and an outer diameter equal to the inner diameter of the semicircular cut-away surface 4u of the cylinder head cover 4.

A semicircular cut-away surface 20u as a semicircular inner circumferential surface of the water pump holder 20 is opposed to a semicircular cut-away surface 3u of the cylinder head 3 to form a water pump support circular hole 21. The water pump 30 is fitted to and held by the water pump support circular hole 21.

With reference to FIGS. 2, 3 and 4, the right sidewall 3wr is formed with the semicircular cut-away surface 3u in the cylinder head 3 and forms the cam chain chamber 17 by partitioning it from the outside. The right sidewall 3wr is formed relatively thick by allowing a semicircular hole edge portion 3e forming the semicircular cut-away surface 3u to protrude outward (rightward). In addition, the right sidewall 3wr is formed with holder attachment bolt boss portions 3hb, 3hb outwardly protruding to form respective projecting ridges which extend vertically. The holder attachment bolt boss portion 3hb, 3hb have respective holder attachment bolt through-holes 3h, 3h vertically bored in front and rear of the semicircular hole edge portion 3e. (See FIG. 3.)

The upper end faces of the holder attachment bolt boss portions 3hb, 3hb are the mating surfaces 3s, 3s which are widely expanded right and left and in the front and rear of the semicircular cut-away surface 3u of the right sidewall 3wr. The holder attachment bolt through-holes 3h, 3h are open in the respective wide mating surfaces 3s, 3s adjacently to the semicircular cut-away surface 3u (see FIG. 4).

In addition, the mating surfaces 3s, 3s in front and rear of the circular cut-away surface 3u are formed with respective small-diameter pin holes 3k, 3k in a further forward and rearward position close to the respective holder attachment bolt through-holes 3h, 3h.

The right sidewalls 3wr of the cylinder head 3 are formed with cylinder head fastening bolt boss portions 3db, 3db which protrude rightward from the respective front and rear lower end portions. The cylinder head fastening bolt boss portions 3db, 3db are vertically bored with respective cylinder head fastening bolt through-holes 3d, 3d.

Further, the external surface of the right sidewall 3wr is formed around the semicircular edge portion 3e with three water pump attachment bolt boss portions 3pb, 3pb, 3pb which project to the right. The water pump attachment bolt boss portions 3pb, 3pb, 3pb are provided with respective water pump attachment bolt internal thread holes 3p, 3p, 3p which extend to the left.

As described above, the right sidewall 3wr which has the semicircular cut-away surface 3u, of the cylinder head 3, holding the water pump 30 and defines part of the cam chain chamber 17 is formed as below. The semicircular hole edge portion 3e defining the semicircular cut-away surface 3u holding the water pump 30 bulges outward and is formed relatively thick. The holder attachment bolt boss portions 3hb, 3hb in front and rear of the semicircular hole edge portion 3e externally bulge to form projecting ridges. The three water pump attachment bolt boss portions 3pb, 3pb, 3pb are formed around the semicircular edge portion 3e so as to project rightward. The cylinder head fastening bolt boss portions 3db, 3db are formed in front and rear of the lower end. Thus, the cylinder head 3 around the cam chain chamber 17 can naturally be increased in rigidity to increase the strength of the head fastening portion.

In addition, the right sidewall 3wr is formed at front and rear corners with upper end portions which bulge to the right along the mating surface 3s of the cylinder head 3 to form respective cover attachment boss portions 3gb, 3gb. In addition, the left side wall is formed at a front side position with an upper end portion which bulges to the left along the mating surface 3s of the cylinder head 3 to form a cover attachment boss portion 3gb.

The three cover attachment boss portions 3gb, 3gb, 3gb are formed with respective internal thread holes 3g, 3g, 3g which open in the mating surface 3s.

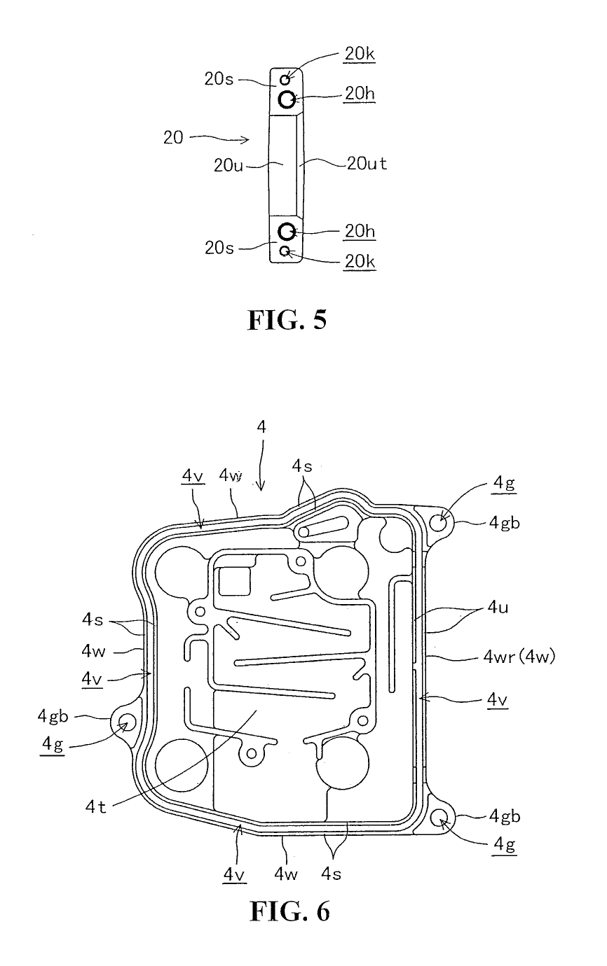

With reference to a back view of FIG. 5, the water pump holder 20 formed as the hollow semicircular plate forming the water pump support circular hole 21 by allowing the semicircular cut-away surface 3u of the cylinder head 3 to face the semicircular cut-away surface 20u is slightly thicker than the semicircular hole edge portion 3e having the same thickness as that of the cylinder head 3. Mating surfaces 20s, 20s allowed to conform with the respective mating surfaces 3s, 3s in front and rear of the semicircular cut-away surface 3u of the cylinder head 3 are formed with bolt internal thread holes 20h, 20h corresponding to the respective holder attachment bolt through-holes 3h, 3h. In addition, the mating surfaces 20s, 20s are formed with respective pin holes 20k, 20k at positions corresponding to respective pin holes 3k, 3k.

Knock pins 22 are generally half fitted into the corresponding pin holes 20k, 20k of the water pump holder 20. In this state, the projecting portions of the knock pins 22 are fitted into the corresponding pin holes 3k, 3k on the side of the cylinder head 3 for positioning. Thus, the mating surfaces 20s, 20s are allowed to precisely conform with the respective mating surfaces 3s, 3s of the cylinder head 3 in the front and rear of the semicircular cut-away surface 3u.

Elongate fastening bolts 23, 23 are passed, from below, through the respective holder attachment bolt through-holes 3h, 3h of the cylinder head 3 and threadedly engaged with the bolt internal thread holes 20h, 20h of the water pump holder 20. Thus, the water pump holder 20 is fastened to the end face of the right sidewall 3wr of the cylinder head 3.

The semicircular cut-away surface 3u of the cylinder head 3 is opposed to the semicircular cut-away surface 20u of the water pump holder 20 to form the water pump support circular hole 21.

In the state where the water pump holder 20 is fastened to the cylinder head 3 as described above, both the semicircular cut-away surface 3u of the cylinder head 3 and the semicircular cut-away surface 20u of the water pump holder 20 which form the water pump support circular hole 21 are subjected to planarization (co-process). Thus, a perfect-circular hole surface with a high degree of accuracy is formed.

In addition, the outer opening edge of the water pump support circular hole 21 is chamfered to form tapered surfaces 3ut, 20ut.

The cylinder head cover 4 put on the cylinder head 3 from above so as to cover the valve train 10 is composed of a rectangular outer lateral wall 4w continuously joined to the rectangular outer lateral wall 3w of the cylinder head 3 and an upper wall 4t. A right sidewall 4wr of the outer lateral wall 4w is such that the mating surface 4s is cut away to form the semicircular cut-away surface 4u having the inner diameter generally equal to the outer diameter of the semicircular outer circumferential surface 20v of the water pump holder 20.

Thus, the mating surface 4s which is an end face of the rectangular outer lateral wall 4w in the cylinder head cover 4 is composed of a surface opposed to the mating surface 3s of the cylinder head 3 and a semicircular cut-away surface 4u opposed to the semicircular outer circumferential surface 20v of the water pump holder 20. A cylinder cover gasket 25 is interposed between such surfaces opposed to each other.

As illustrated in FIG. 6, the mating surface 4s of the cylinder head cover 4 is formed with an endless groove 4v.

Anteroposterior lower ends of the right sidewall 4wr along the mating surface 4s bulge forward to form respective attachment boss portions 4gb, 4gb. A front lower end of the left sidewall along the mating surface 4s bulges leftward to form an attachment boss portion 4gb.

The three attachment boss portions 4gb, 4gb, 4gb are bored with respective bolt through-holes 4g, 4g, 4g.

The projecting ridge of a cylinder cover gasket 25 T-shaped in cross-section is fitted to the groove 4v formed on the mating surface 4s of the cylinder head cover 4 so that the cylinder gasket 25 is attached to the mating surface 4s.

The cylinder head cover 4 where the cylinder cover gasket 25 is attached to the mating surface 4s is put on the cylinder head 3 attached with the water pump holder 20. The cylinder cover gasket 25 is liquid-tightly sandwiched between the mating surface 4s of the cylinder head cover 4, and the mating surface 3s of the cylinder head 3 and the semicircular outer circumferential surface 20v of the water pump holder 20. The bolts 6 are passed though the bolt through-holes 4g and threadedly engaged with the bolt internal thread holes 20h. Thus, the cylinder head cover 4 is attached to the cylinder head 3.

The water pump support circular hole 21 formed by fastening the water pump holder 20 to the cylinder head 3 has a central axis aligned with that of the camshaft 11.

The water pump 30 is fitted into and supported by the water pump support circular hole 21.

With reference to FIGS. 1 to 7, a water pump housing 31 of the water pump 30 includes an elongate cylindrical portion 31a and a short cylindrical portion 31b. The elongate cylindrical portion 31a extends axially and rotatably supports a water pump drive shaft 33 via a bearing 35. The short cylindrical portion 31b expands radially but is axially short. In addition, the short cylindrical portion 31b has an axially extending opening end to partially house an impeller 34 fitted to the water pump drive shaft 33. A water pump cover 32 is superimposed on the opening end face of the short cylindrical portion 31b. This water pump cover 32 shields the right opening of the short cylindrical portion 31b of the water pump housing 31 and houses the impeller 34 along with the short cylindrical portion 31b.

The short cylindrical portion 31b of the water pump housing 31 is formed with four bolt holes 31h on the outer circumference. Also the water pump cover 32 is formed with four bolt holes 32h corresponding to the respective bolt holes 31h of the water pump housing 31.

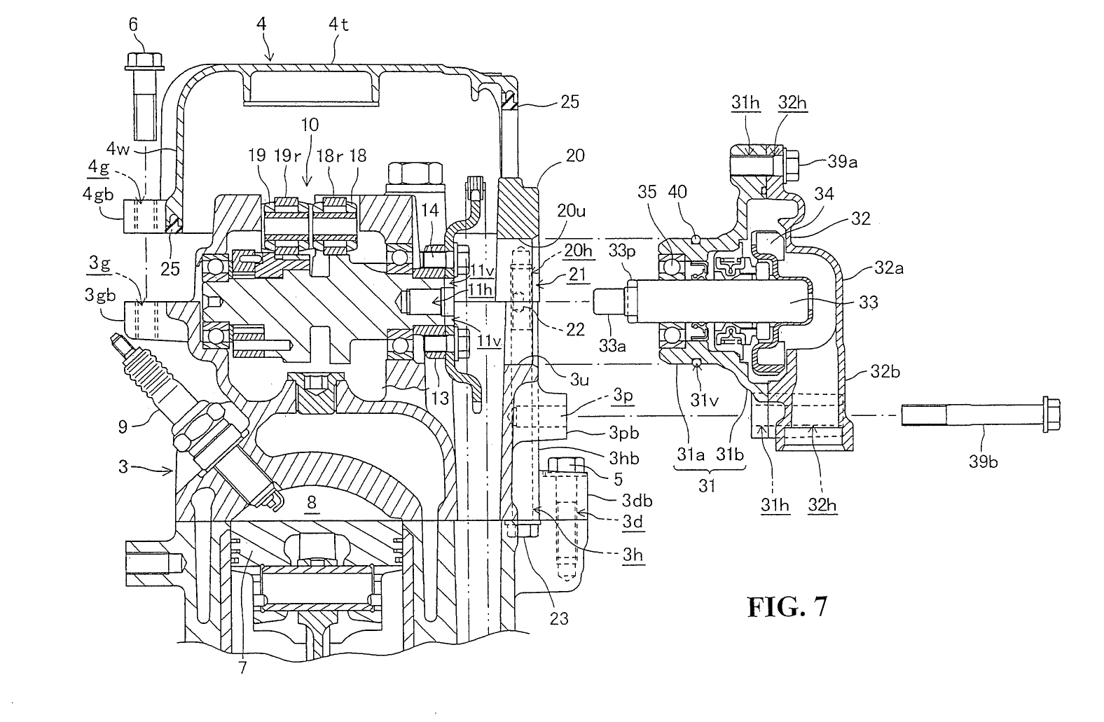

As illustrated in FIG. 7, the bolt internal thread hole 31h of the water pump housing 31 located close to the upper portion of the cylinder head cover 4 is threaded with female screws. In addition, a bolt 39a passed through the corresponding bolt hole 32h of the water pump cover 32 is threadedly engaged with the corresponding bolt internal thread hole 31h to fasten the water pump cover 32 to the water pump housing 31.

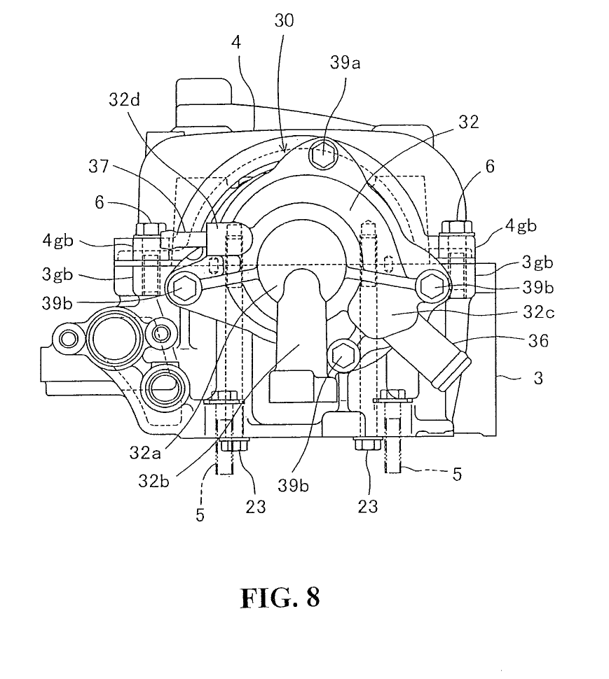

The other three bolt holes 31h, 32h correspond to the respective three water pump attachment internal thread holes 3p (see FIG. 3) formed in the right sidewall 3wr of the cylinder head 3 and are superimposed to the respective water pump attachment bolt boss portions 3pb. Bolts 39b are passed through the corresponding bolt holes 32h, 31h and threadedly engaged with the corresponding water pump attachment bolt internal thread holes 3p (see FIGS. 1 and 8) to co-fasten the water pump housing 31 and the water pump cover 32 to the right sidewall 3wr of the cylinder head 3. In this way, the water pump 30 is attached to the cylinder head 3.

In addition, referring to FIG. 8, the water pump cover 32 is formed as below. An intake port portion 32a protrudes toward the right of the water pump drive shaft 33. A water suction cylindrical portion 32b extends from the intake port portion 32a in the direction of the crankshaft along the right lateral surface of the cylinder head 3. A discharge port portion 32c extends obliquely rearward and downward from the outer circumferential lower portion of the impeller 34 in a tangential direction. Further, a discharge connection pipe 36 is further provided to project from the discharge port portion 32c.

An air-bleeding portion 32d is formed at an upper rear portion on the outer circumference of the impeller 34. In addition, an air-bleeding connection pipe 37 is provided to project obliquely rearwardly and upwardly from the air-bleeding portion 32d.

As illustrated in FIG. 7, the elongate cylindrical portion 31a fitted into the water pump support circular hole 21 of the water pump housing 31 is fully circumferentially formed with an outer circumferential groove 31v on the outer circumferential surface thereof. An O-ring 40 is fitted to the outer circumferential groove 31v. The O-ring 40 is sandwiched between the semicircular cut-away surfaces 3u, 20u of the water pump support circular hole 21 formed with a high degree of accuracy by a co-process. Thus, the water pump housing 31 is liquid-tightly fitted into the water pump support circular hole 21 and reliably sealed and attached thereto.

In addition, the outer opening edge of the water pump support circular hole 21 is chamfered to form the tapered surfaces 3ut, 20ut. Therefore, the water pump support circular hole 21 can be positioned with respect to the elongate cylindrical portion 31a of the water pump housing 31 and the elongate cylindrical portion 31a can easily be fitted into the water pump support circular hole 21.

When the water pump 30 is fitted into the water pump support circular hole 21, a reduced-diameter end portion 33a of the water pump drive shaft 33 is inserted into a fitted-into hole 11h of an end face of the cam shaft 11 located axially therewith. A pin 33p is diametrically fitted into the reduced-diameter end portion 33a and has both ends projecting therefrom. Both the ends of the pin 33p are fitted into respective grooves 11v, 11v resulting from diametrically cutting away an opening end edge of the fitted-into hole 11h and are joined thereto. The rotation of the camshaft 11 is transmitted to the water pump drive shaft 33 coaxially connected thereto so that the camshaft 11 and the water pump drive shaft 33 are rotated together. Thus, the water pump 30 is driven to circulate cooling water to cool the internal combustion engine 1.

In the water pump attachment structure of the internal combustion engine 1, while maintaining the state where the water pump 30 is fitted into the water pump support circular hole 21 and secured to the cylinder head 3, the cylinder head cover 4 can be removed. Therefore, the maintenance work of the valve train 10 such as the adjustment of a tappet clearance can be done with ease.

In addition, in the state where the cylinder head cover 4 is put on and fastened to the cylinder head 3, the water pump 30 can be removed. Therefore, also the maintenance work of the water pump 30 can be facilitated.

In addition, the water pump 30 directly driven by the camshaft 11 coaxially connected to the pump drive shaft 33 is disposed across the mating surface of the cylinder head 3 and the mating surface 4s of the cylinder head cover 4. The mating surfaces 3s, 4s are made flush with the cam shaft 11 to lower the upper end of the outer lateral wall 3w of the cylinder head 3, thus reducing the weight of the cylinder head 3.

The water pump holder 20 is fastened to the cylinder head 3 by being positioned with respect thereto by means of the knock pins 22 engaged with the respective engaging holes 3k, 20k formed at the respective given positions of the mating surfaces 3s, 20s. Therefore, the accuracy of the attachment position of the water pump holder 20 to the cylinder head 3 can be highly maintained. In addition, the sealing performance can made satisfactory when the water pump 30 is fitted into and supported by the water pump support circular hole 21.

The holder attachment bolt through-holes 3h, 3h of the cylinder head 3 are formed adjacent to and on both sides of the semicircular cut-away surface 3u. The semicircular cut-away surface 3u of the cylinder head 3 is formed to have an axial width greater than the inner diameter of the holder attachment bolt through-hole 3h. Therefore, while making the support of the water pump 30 satisfactory, the broad semicircular cut-away surface is used to enlarge the holder attachment bolt boss portions 3hb of the holder attachment bolt through-holes 3h, thereby increasing the boss strength.

The semicircular cut-away surfaces 3u, 20u of the water pump support circular hole 21 formed by fastening the water pump holder 20 to the cylinder head 3 are subjected to planarization by the co-process. Therefore, the water pump support circular hole 21 can be made as a perfect-circular hole surface with a high degree of accuracy. The elongate cylindrical portion 31a of the water pump housing 31 of the water pump 30 is liquid-tightly fitted into the water pump support circular hole 21 via the O-ring 40. With such a simple structure, high sealing performance can be ensured.

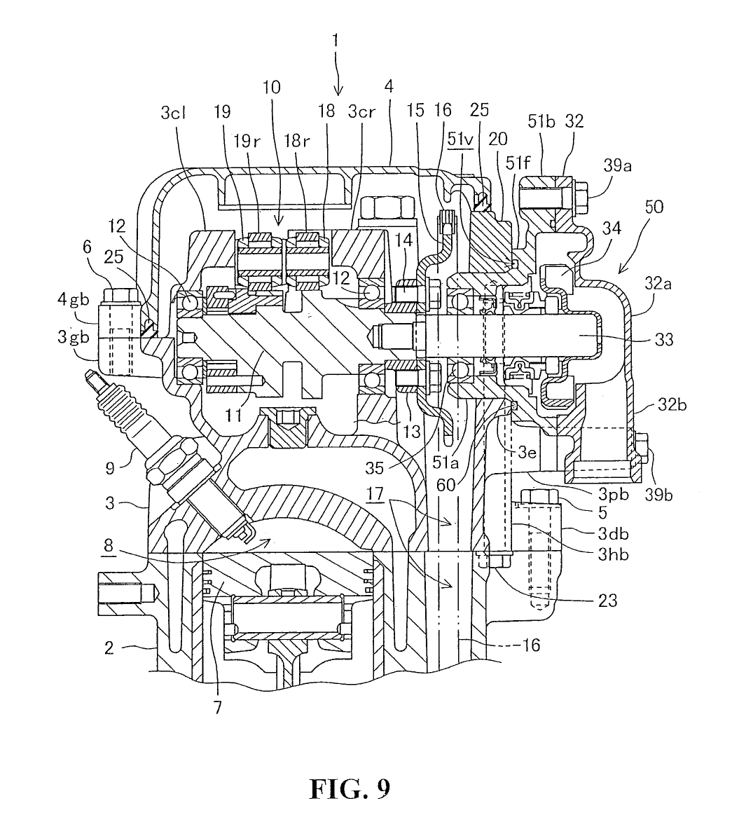

A description is next given of another sealing structure for the attachment of a water pump by way of example with reference to FIG. 9.

A water pump 50 of this embodiment is the same as that of the embodiment described above except for a water pump housing 51. Therefore, the other elements are indicated with like reference numerals in the embodiment described above.

An elongate cylindrical portion 51a of the water pump housing 51 is formed integrally with a flange portion 51f at an enlarged-diameter portion of a short cylindrical portion 51b. The flange portion 51f is opposed to a right lateral surface of the right sidewall 3wr of the cylinder head 3 and to a right lateral surface of the water pump holder 20, the right sidewall 3wr and the water pump holder 20 forming the water pump support circular hole 21 and both the right lateral surfaces being flush with each other. A circular groove 51v is formed around the pump drive shaft 33 and in a plane of the flange portion 51f opposed to the right sidewall 3wr of the cylinder head 3 and to the water pump holder 20.

An O-ring 60 is fitted into the circular groove 51v. In this state, the elongate cylindrical portion 51a of the water pump housing 51 is fitted into the water pump support circular hole 21. The flange portion 51f is brought into liquid-tight abutment against the outer opening end face (the respective right lateral surfaces of the right sidewall 3wr of the cylinder head 3 and the water pump holder 20) of the water pump support circular hole 21. In this way, the water pump 50 is secured to the cylinder head 3 by means of bolts 39b. With such a simple structure, the sealing performance can be highly maintained.

In this structure, it is not necessary to co-process the cylinder head 3 and the water pump holder 20.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A water pump attachment structure for a water-cooled internal combustion engine, in which a valve train having a camshaft disposed on a cylinder head is provided so as to be covered by a cylinder head cover comprising:
a water pump having a pump drive shaft directly driven by the camshaft is disposed across a mating surface of the cylinder head and a mating surface of the cylinder head cover,
wherein the cylinder head has a sidewall formed with a semicircular cut-away surface resulting from cutting away the mating surface with the cylinder head cover in a semicircle, and has screw boss portions having screw through-holes passing through the mating surface, the screw boss portions being formed on both sides of the semicircular cut-away surface,
a water pump holder, formed with a semicircular cut-away surface symmetrically opposed to the semicircular cut-away surface of the cylinder head, and with internal thread holes in the mating surface with the cylinder head so as to correspond to the respective screw through-holes, forms a water pump support circular hole by allowing a semicircular cut-away surface thereof to face the semicircular cut-away surface of the cylinder head, and screw members are passed through the respective screw through-holes of the cylinder head and are threadedly engaged with the respective internal thread holes of the water pump holder for fastening the water pump holder to the cylinder head,
a water pump is fitted into and secured to the water pump support circular hole, and
the mating surface of the cylinder head cover conforms to the mating surface of the cylinder head and is attached to the cylinder head with the water pump holder liquid-tightly sandwiched therebetween.

2. The water pump attachment structure of the water-cooled internal combustion engine according to claim 1,
wherein the water pump holder is positioned with respect to and fastened to the cylinder head by a knock pin engaged with an engaging hole formed at a given position on the mating surface of the cylinder head and of the water pump holder.

3. The water pump attachment structure of the water-cooled internal combustion engine according to claim 1,
wherein the screw through-holes of the cylinder head are formed adjacent to both respective sides of the semicircular cut-away surface, and
the semicircular cut-away surface of the cylinder head has an axial width greater than an internal diameter of the screw through-hole.

4. The water pump attachment structure of the water-cooled internal combustion engine according to claim 2,
wherein the screw through-holes of the cylinder head are formed adjacent to both respective sides of the semicircular cut-away surface, and
the semicircular cut-away surface of the cylinder head has an axial width greater than an internal diameter of the screw through-hole.

5. The water pump attachment structure of the water-cooled internal combustion engine according to claim 3,
wherein the corresponding semicircular cut-away surfaces of the water pump support circular hole formed by fastening the water pump holder to the cylinder head are subjected to planarization by a co-process, and
a cylindrical portion of a water pump housing rotatably supporting the pump drive shaft of the water pump is liquid-tightly fitted into the water pump support circular hole via an O-ring to support the water pump.

6. The water pump attachment structure of the water-cooled internal combustion engine according to claim 4,
wherein the corresponding semicircular cut-away surfaces of the water pump support circular hole formed by fastening the water pump holder to the cylinder head are subjected to planarization by a co-process, and
a cylindrical portion of a water pump housing rotatably supporting the pump drive shaft of the water pump is liquid-tightly fitted into the water pump support circular hole via an O-ring to support the water pump.

7. The water pump attachment structure of the water-cooled internal combustion engine according to claim 3,
wherein a cylindrical portion of a water pump housing rotatably supporting the pump drive shaft of the water pump is formed with a flange portion, and
the cylindrical portion of the water pump housing is fitted into the water pump support circular hole so that the flange portion is liquid-tightly abutted against an external opening end face of the water pump support circular hole via an O-ring to support the water pump.

8. The water pump attachment structure of the water-cooled internal combustion engine according to claim 1,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.

9. The water pump attachment structure of the water-cooled internal combustion engine according to claim 2,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.

10. The water pump attachment structure of the water-cooled internal combustion engine according to claim 3,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.

11. The water pump attachment structure of the water-cooled internal combustion engine according to claim 5,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.

12. The water pump attachment structure of the water-cooled internal combustion engine according to claim 7,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.

13. A water pump attachment structure for a water-cooled internal combustion engine wherein a valve train with a camshaft disposed on a cylinder head is covered by a cylinder head cover comprising:
a water pump having a pump drive shaft directly driven by the camshaft, said water pump being disposed across a mating surface of the cylinder head and a mating surface of the cylinder head cover;
a sidewall of the cylinder head includes a semicircular cut-away surface formed by cutting away the mating surface with the cylinder head cover in a semicircle;
screw boss portions formed in the sidewall with screw through-holes passing through the mating surface, the screw boss portions being formed on both sides of the semicircular cut-away surface;
a water pump holder formed with a semicircular cut-away surface symmetrically opposed to the semicircular cut-away surface of the cylinder head;
internal thread holes being formed in the mating surface with the cylinder head to correspond with the respective screw through-holes for forming a water pump support circular hole by positioning a semicircular cut-away surface thereof to face the semicircular cut-away surface of the cylinder head; and
screw members positioned through the respective screw through-holes of the cylinder head and being threadedly engaged with the respective internal thread holes of the water pump holder for fastening the water pump holder to the cylinder head;
said mating surface of the cylinder head cover conforming to the mating surface of the cylinder head and being attached to the cylinder head with the water pump holder liquid-tightly sandwiched therebetween.

14. The water pump attachment structure of the water-cooled internal combustion engine according to claim 13,
wherein the water pump holder is positioned with respect to and fastened to the cylinder head by a knock pin engaged with an engaging hole formed at a given position on the mating surface of the cylinder head and of the water pump holder.

15. The water pump attachment structure of the water-cooled internal combustion engine according to claim 13,
wherein the screw through-holes of the cylinder head are formed adjacent to both respective sides of the semicircular cut-away surface, and
the semicircular cut-away surface of the cylinder head has an axial width greater than an internal diameter of the screw through-hole.

16. The water pump attachment structure of the water-cooled internal combustion engine according to claim 14,
wherein the screw through-holes of the cylinder head are formed adjacent to both respective sides of the semicircular cut-away surface, and
the semicircular cut-away surface of the cylinder head has an axial width greater than an internal diameter of the screw through-hole.

17. The water pump attachment structure of the water-cooled internal combustion engine according to claim 15,
wherein the corresponding semicircular cut-away surfaces of the water pump support circular hole formed by fastening the water pump holder to the cylinder head are subjected to planarization by a co-process, and
a cylindrical portion of a water pump housing rotatably supporting the pump drive shaft of the water pump is liquid-tightly fitted into the water pump support circular hole via an O-ring to support the water pump.

18. The water pump attachment structure of the water-cooled internal combustion engine according to claim 16,
wherein the corresponding semicircular cut-away surfaces of the water pump support circular hole formed by fastening the water pump holder to the cylinder head are subjected to planarization by a co-process, and
a cylindrical portion of a water pump housing rotatably supporting the pump drive shaft of the water pump is liquid-tightly fitted into the water pump support circular hole via an O-ring to support the water pump.

19. The water pump attachment structure of the water-cooled internal combustion engine according to claim 15,
wherein a cylindrical portion of a water pump housing rotatably supporting the pump drive shaft of the water pump is formed with a flange portion, and
the cylindrical portion of the water pump housing is fitted into the water pump support circular hole so that the flange portion is liquid-tightly abutted against an external opening end face of the water pump support circular hole via an O-ring to support the water pump.

20. The water pump attachment structure of the water-cooled internal combustion engine according to claim 13,
wherein an external sidewall defining a cam chain chamber of the cylinder head includes a water pump attachment bolt boss portion adapted to secure the water pump and with a cylinder head fastening bolt boss portion adapted to fasten the cylinder head to a cylinder block.
